(19) United States
(12) Patent Application Publication
(10) Pub. No.: US 2022/0291532 A1
(43) Pub. Date: Sep. 15, 2022

(54) LITHIUM NIOBATE OPTICAL WAVEGUIDE CHIP

(71) Applicant: IRIXI PHOTONICS (SUZHOU) CO., LTD., Suzhou (CN)

(72) Inventors: Yifan CHEN, Suzhou (CN); Meng HUANG, Suzhou (CN)

(21) Appl. No.: 17/632,624

(22) PCT Filed: Nov. 18, 2019
(86) PCT No.: PCT/CN2019/119092

§ 371 Date: Feb. 3, 2022

(30) Foreign Application Priority Data
Aug. 22, 2019 (CN) 201910776688.5

(51) Int. Cl. G02F 1/035

(52) U.S. Cl. CPC G02F 1/035; G02F 2202/20

(57) ABSTRACT

A lithium niobate optical waveguide chip includes a monocrystalline silicon substrate, a lithium niobate film, a negative thermo-optical coefficient material disposed on the lithium niobate film, a silicon dioxide cladding disposed on the monocrystalline silicon substrate and coating the lithium niobate film and the negative thermo-optical coefficient material, and a metal electrode disposed on the silicon dioxide cladding. The lithium niobate film includes a lithium niobate central ridge, or a proton exchange layer and lithium niobate side wings. The present invention eliminates the sensitivity of the effective refractive index of the lithium niobate optical waveguides to temperature by disposing the negative thermo-optical coefficient material layer with appropriate thickness on the lithium niobate film, realizes the design of non-thermal photoelectric devices, effectively reduces the thermo-optical coefficient of the lithium niobate optical waveguide chip, and makes the performance of the lithium niobate optical waveguide chip insensitive to temperature change.

### CROSS REFERENCE TO RELATED APPLICATIONS

This application claims priority of Chinese Patent Application No. 201910776688.5, filed Aug. 22, 2019, the entire disclosures of both of which are incorporated herein by reference.

### FIELD OF THE INVENTION

The disclosure belongs to the technical field of photoelectric device, and particularly relates to a lithium niobate optical waveguide chip.

### DESCRIPTION OF THE PRIOR ART

Lithium niobate is one of the materials widely used in photoelectric device. The photoelectric characteristics of lithium niobate, such as low operating voltage, low transmission loss and other advantages, make it used in the manufacture of a variety of photoelectric devices, for example, optical waveguides, high-speed optical modulators, optical frequency converters, etc. In recent years, the development of lithium niobate-on-Insulator has made lithium niobate film optical waveguides compatible with modern integrated circuit manufacturing processes widely studied. Lithium niobate film optical waveguides can be used in high-speed photoelectric devices such as Maher-Zendel light modulators and micro-ring resonators, etc. The traditional lithium niobate optical waveguides form light waveguide structures on lithium niobium crystal by titanium diffusion, in this way, the refractive index difference of light waveguide formed is low, and does not have a strong ability of optical confinement. The position and shape of the single-crystal lithium niobate film optical waveguides based on the lithium niobate-on-insulator are generally decided by etching, with the thin thickness (less than 1 micron), large refractive index difference and strong optical confinement ability. This new lithium niobate optical waveguides can be modulated with lower voltages, also has higher bandwidth and lower transmission losses, which are ideal for the application of photoelectric devices represented by Maher-Zendel light modulators and micro-ring resonators. Lithium niobate optical waveguides need to ensure the operating mode of single-mode transmission, especially in the optical communication wavelength of 1310 nm and 1550 nm, the working mode of single-mode transmission is the basic working mode of most photoelectric devices. To ensure the reliable and stable operation of the lithium niobate optical waveguide devices, the effective refractive index of the optical waveguide should be kept constant under ideal circumstances. However, the refractive index of lithium niobate and silicon oxide as the cladding layer of the device both increase with the increasing temperature. During the operation of the devices, the ambient temperature changes over time, resulting in the change of the devices' effective refractive index, which will seriously affect the performance of the devices. Therefore, a technical scheme is needed to realize the design of non-thermal photoelectric devices.

### BRIEF SUMMARY OF THE INVENTION

An exemplary embodiment of the disclosure aims to provide a lithium niobate optical waveguide chip, which can effectively reduce the thermo-optical coefficient of the optical waveguides, so as to make the performance of the devices insensitive to temperature change.

To achieve the foregoing objective, the present invention is realized as a lithium niobate optical waveguide chip, which includes: a monocrystalline silicon substrate, a lithium niobate film, a negative thermo-optical coefficient material disposed on the lithium niobate film, a silicon dioxide cladding disposed on the monocrystalline silicon substrate and coating the lithium niobate film and the negative thermo-optical coefficient material, and a metal electrode disposed on the silicon dioxide cladding; the lithium niobate film comprises a lithium niobate central ridge, or comprises a proton exchange layer and lithium niobate side wings.

Further, the thermal-optical coefficient of the lithium niobate optical waveguide chip is in the range of 10⁻⁸ to 10⁻⁷.

Further, the width of the lithium niobate central ridge is in the range of 0.7 μm to 1.5 μm, and the width of the proton exchange layer is in the range of 0.7 μm to 1.5 μm.

Further, the silicon dioxide cladding layer comprises a lower cladding layer disposed between the lithium niobate film and monocrystalline silicon substrate, and an upper cladding layer disposed above the negative thermo-optical coefficient material; and the metal electrode is disposed on opposite sides of the upper cladding.

Further, the lithium niobate optical waveguide chip is ridge optical waveguide, the lithium niobate film comprises the lithium niobate central ridge and lithium niobate side wings stretching from the lithium niobate center ridge to both sides, the lithium niobate central ridge is convexly disposed on the lower cladding layer, the lithium niobate side wings stretched parallelly on the lower cladding layer; and the negative thermo-optical coefficient material is disposed on the lithium niobate central ridge and lithium niobate side wings; and the width of the lithium niobate central ridge is W, the thickness of the negative thermo-optical coefficient material (taking titanium dioxide as an example) is H, and satisfies H²:W=0.034-0.041.

Further, the lithium niobate optical waveguide chip is linear optical waveguide, the lithium niobate film comprises the lithium niobate central ridge, the lithium niobate central ridge is convexly disposed on the lower cladding layer, the negative thermo-optical coefficient material is disposed on the lithium niobate central ridge; and the width of the lithium niobate central ridge is W, the thickness of the negative thermo-optical coefficient material (taking titanium dioxide as an example) is H, and satisfies H²:W=0.02-0.032.

Further, the lithium niobate optical waveguide chip is proton exchange optical waveguide, the lithium niobate film comprises the proton exchange layer and lithium niobate side wings stretching from the proton exchange layer to both sides, the proton exchange layer and lithium niobate side wings are arranged parallel to the lower cladding layer, the negative thermo-optical coefficient material is disposed on the proton exchange layer and lithium niobate side wings; the width of the proton exchange layer is W, the thickness of the negative thermo-optical coefficient material (taking titanium dioxide as an example) is H, and satisfies H²:W=0.037-0.042.

Further, the lithium niobate optical waveguide chip is channel optical waveguide, the lithium niobate film comprises the lithium niobate central ridge, which is concavely disposed in the lower cladding layer, the negative thermo-optical coefficient material is disposed on the lithium niobate central ridge and parallel to the lower cladding layer; the width of the lithium niobate central ridge is W, the thickness of the negative thermo-optical coefficient material (taking titanium dioxide as an example) is H, and satisfies H²:W=0.017-0.02.

Further, the proton exchange layer is proton-exchanged lithium niobate.

Further, the negative thermo-optical coefficient material is selected from one or more of titanium dioxide, zinc oxide, magnesium doped zinc oxide, polymethyl methacrylate, polystyrene, and methylammonium lead halide.

Compared with the prior art, the beneficial effect of the foregoing technical solution is: since the refractive index of lithium niobate and silicon oxide increases along with temperature rise, on the basis of the characteristics that the refractive index of titanium dioxide decreases along with temperature rise, the present invention can eliminate the sensitivity of the effective refractive index of the lithium niobate optical waveguides to temperature by disposing the titanium dioxide layer with appropriate thickness on the lithium niobate film. The present invention realizes the design of non-thermal photoelectric devices, can effectively reduce the thermo-optical coefficient of the lithium niobate optical waveguides, so as to make the performance of the lithium niobate optical waveguides insensitive to temperature change.

The above description is only an outline of the technical schemes of the present invention. Preferred embodiments of the present invention are provided below in conjunction with the attached drawings to enable one with ordinary skill in the art to better understand said and other objectives, features, and advantages of the present invention and to make the present invention accordingly.

### BRIEF DESCRIPTION OF THE DRAWINGS

FIG. 1 is a structural diagram depicting the lithium niobate optical waveguide in embodiment 1 of the present invention.

FIG. 2a is a curve depicting the relationship between the temperature and the effective refractive of the lithium niobate optical waveguide in embodiment 1 of the present invention.

FIG. 2b (FIG. 1 of annex 1) is a schematic diagram depicting the optical fields distribution of the lithium niobate optical waveguide in embodiment 1 of the present invention.

FIG. 3a is a curve depicting the relationship between the thermo-optical coefficient and width of the lithium niobate optical waveguide in embodiment 1 of the present invention.

FIG. 3b is a curve depicting the relationship between the thermo-optical coefficient of the lithium niobate optical waveguide and the thickness of the titanium dioxide layer in embodiment 1 of the present invention.

FIG. 4 is a structural diagram depicting the lithium niobate optical waveguide in embodiment 2 of the present invention.

FIG. 5a is a curve depicting the relationship between the temperature and the effective refractive of the lithium niobate optical waveguide in embodiment 2 of the present invention.

FIG. 5b (FIG. 2 of annex 1) is a schematic diagram depicting the optical fields distribution of the lithium niobate optical waveguide in embodiment 2 of the present invention.

FIG. 6a is a curve depicting the relationship between the thermo-optical coefficient and width of the lithium niobate optical waveguide in embodiment 2 of the present invention.

FIG. 6b is a curve depicting the relationship between the thermo-optical coefficient of the lithium niobate optical waveguide and the thickness of the titanium dioxide layer in embodiment 2 of the present invention.

FIG. 7 is a structural diagram depicting the lithium niobate optical waveguide in embodiment 3 of the present invention.

FIG. 8a is a curve depicting the relationship between the temperature and the effective refractive of the lithium niobate optical waveguide in embodiment 3 of the present invention.

FIG. 8b (FIG. 3 of annex 1) is a schematic diagram depicting the optical fields distribution of the lithium niobate optical waveguide in embodiment 3 of the present invention.

FIG. 9a is a curve depicting the relationship between the thermo-optical coefficient and width of the lithium niobate optical waveguide in embodiment 3 of the present invention.

FIG. 9b is a curve depicting the relationship between the thermo-optical coefficient of the lithium niobate optical waveguide and the thickness of the titanium dioxide layer in embodiment 3 of the present invention.

FIG. 10 is a structural diagram depicting the lithium niobate optical waveguide in embodiment 4 of the present invention.

FIG. 11a is a curve depicting the relationship between the temperature and the effective refractive of the lithium niobate optical waveguide in embodiment 4 of the present invention.

FIG. 11b (FIG. 4 of annex 1) is a schematic diagram depicting the optical fields distribution of the lithium niobate optical waveguide in embodiment 4 of the present invention.

FIG. 12a is a curve depicting the relationship between the thermo-optical coefficient and width of the lithium niobate optical waveguide in embodiment 4 of the present invention.

FIG. 12b is a curve depicting the relationship between the thermo-optical coefficient of the lithium niobate optical waveguide and the thickness of the titanium dioxide layer in embodiment 4 of the present invention.

### DETAILED DESCRIPTION OF THE PREFERRED EMBODIMENTS

Specific embodiments of the present invention are described in further detail in combination with the related drawings and embodiments below. However, in addition to the descriptions given below, the present invention can be applied to other embodiments, and the scope of the present invention is not limited by such, rather by the scope of the claims.

The terms “up”, “down”, “left”, “right”, “inside” and “outside” of the present invention are only describe the present invention with reference to the attached drawings and are not used as limiting terms.

The lithium niobate optical waveguide of the present invention includes: a lithium niobate film, a titanium dioxide layer disposed on the lithium niobate film, a silicon dioxide cladding coating the lithium niobate film and the titanium dioxide layer, and a metal electrode disposed on the silicon dioxide cladding; the lithium niobate film comprises a lithium niobate central ridge, or comprises a proton exchange layer and lithium niobate side wings.

The thermal-optical coefficient of the lithium niobate optical waveguide can be reduce to 10⁻⁸-10⁻⁷, through the structural design of the present invention. Considering the process, thermo-optical coefficient, guided wave performance, etc, the width of the lithium niobate central ridge is 0.7-1.5 μm, and the width of the proton exchange layer is 0.7-1.5 μm.

The lithium niobate optical waveguide in the present invention is based on the lithium niobate-on-insulator, i.e. the lithium niobium film-silica-silicon composite wafer structure. For the ridge optical waveguide and linear optical waveguide, firstly, the position and shape of the optical waveguides are decided by electron beam lithography or optical lithography; and then the optical waveguides are made by ion milling, RIE (Reactive Ion Etching), ICP-RIE, wet etch, or crystal ion slicing. For the channel optical waveguides, an additional silicon dioxide layer needs to be deposited after the etching step, so as to make the top of the silicon dioxide flush with the top of the lithium niobate optical waveguide. For the proton exchange optical waveguides, lithium niobate needs to be immersed in high temperature acid solution for exchange to form proton-exchanged lithium niobate. The lithium niobate can then be used as optical waveguide devices after cladded by silicon dioxide and evaporating metal electrodes. The silicon dioxide claddings grow by PECVD (Plasma Enhanced Chemical Vapor Deposition), CVD (Chemical Vapor Deposition) or PVD (Physical Vapor Deposition). For the negative thermo-optical coefficient materials, the titanium dioxide layers are prepared by Reactive Sputtering, RF Magnetron Sputtering, PECVD, CVD, ALD (Atomic Layer Deposition), PLD (Pulse Laser Deposition), etc; the zinc oxide and magnesium doped zinc oxide can also be prepared by Reactive Sputtering, RF Magnetron Sputtering, PECVD, CVD, ALD, PLD, etc; and other organic materials can be prepared by Spin-Coating.

In the design of the optical waveguide structures, the present invention is guided by the Helmholtz scale equation, i.e.,

∇²Ψ(x,y,z)+k₀²n²(x,y)Ψ(x,y,z)=0

Where Ψ can be any field component, k₀ is the vacuum wave number, n is the refractive index, z direction is the propagation direction, x and y directions are the vertical and parallel directions of the cross section, respectively. To obtain the solution of this equation, it can be simplified as follows by the effective refractive index method:

$$\frac{1}{F ( x , y )} \frac{{δ}^{2} F}{δ {x}^{2}} + {k}_{0}^{2} {n}^{2} ( x , y ) = {k}_{0}^{2} {n}_{eff}^{2} ( y )$$

$$\frac{1}{G ( y )} \frac{{d}^{2} G}{{dy}^{2}} - {β}^{2} = - {k}_{0}^{2} {n}_{eff}^{2} ( y )$$

Where F and G are the distributions of modal field, n_{eff} is the effective refractive index, and β is the propagation constant. The propagation constant and effective refractive index of the optical waveguides can be calculated by this method.

Next, the present invention will be further explained in combination with concrete embodiments.

### Embodiment 1: The Ridge Optical Waveguide

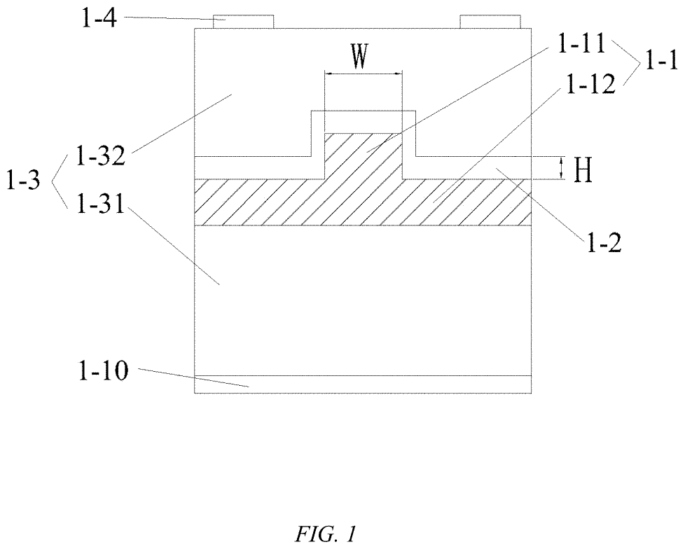

Referring to FIG. 1, in this embodiment, the lithium niobate optical waveguide is a ridge optical waveguide, and the optimal thermo-optical coefficient of the optical waveguide chip with this structure at 20-50° C. is 4×10⁻⁸. As a comparison, the thermo-optical coefficient of the optical waveguide without titanium dioxide (replaced by silicon dioxide) in the same structure at 20-50° C. is 3.7×10⁻⁵.

In this embodiment, the lithium niobate optical waveguide comprises a monocrystalline silicon substrate (1-10), a lithium niobate film (1-1), a titanium dioxide layer (1-2) disposed on the lithium niobate film (1-1), a silicon dioxide cladding (1-3) coating the lithium niobate film (1-1) and the titanium dioxide layer (1-2), and metal electrodes (1-4) disposed on the silicon dioxide cladding (1-3). The thickness of the lithium niobate file (1-1) is 300 nm, which comprises a lithium niobate central ridge (1-11) and lithium niobate side wings (1-12) stretching from the lithium niobate center ridge (1-11) to both sides.

The silicon dioxide cladding layer (1-3) comprises a lower cladding layer (1-31) disposed below the lithium niobate film (1-1) and an upper cladding layer (1-32) disposed above the titanium dioxide layer (1-2). The thickness of the lower cladding layer (1-31) is 4.7 μm, and the thickness of the upper cladding layer (1-32) is 1.5 μm. The lower cladding layer (1-31) is disposed on the monocrystalline silicon substrate (1-10), the lithium niobate central ridge (1-11) is convexly disposed on the lower cladding layer (1-31), the lithium niobate side wings (1-12) stretched parallelly on the lower cladding layer (1-31), the titanium dioxide layer (1-2) is disposed on the lithium niobate central ridge (1-11) and the lithium niobate side wings (1-12), and the metal electrodes (1-4) are disposed on opposite sides of the upper surfaces of the upper cladding layer (1-32).

Disposing metal electrodes on opposite sides of lithium niobate optical waveguide, the pockels effect makes the refractive index of the lithium niobate crystal change when an electric field is applied between the electrodes. Therefore, lithium niobate optical waveguide is naturally suitable for Mach-Zehnder modulator.

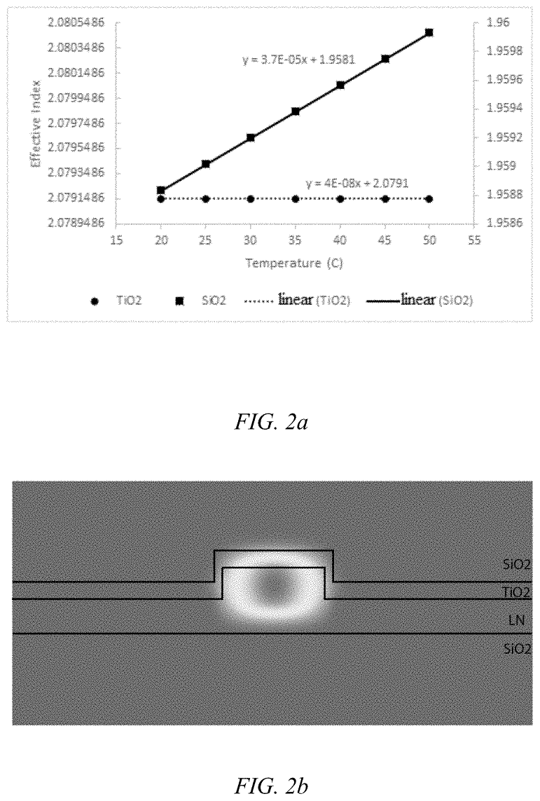

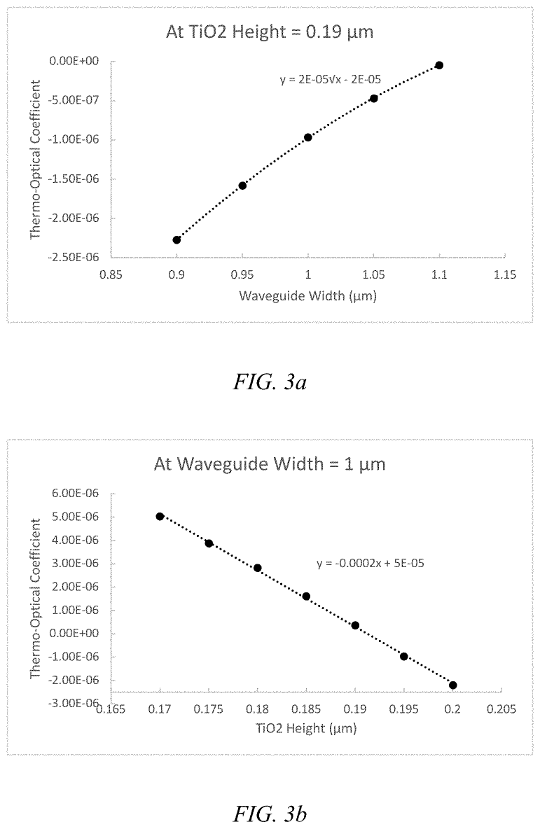

In this embodiment, the width of the lithium niobate central ridge (1-11) is W, the thickness of the titanium dioxide layer (1-2) is H, and satisfies H²:W=0.034-0.041, so as to ensure the effective thermal-optical coefficient of the optical waveguide in this embodiment is 10⁻⁸-10⁻⁷. FIG. 2a and FIG. 2b (FIG. 1 of annex 1) show the variation of effective refractive index with temperature and the distribution of optical fields of this optical waveguide structure, respectively. FIG. 3a and FIG. 3b show the variation of effective refractive index with the width of this optical waveguide structure and the thickness of the titanium dioxide layer, respectively.

If zinc oxide is used as the negative thermal-optical coefficient material, the optimal thermal-optical coefficient of the ridge optical waveguide with zinc oxide layer at 20-50° C. is 3.3×10⁻⁹. As a comparison, the thermo-optical coefficient of the optical waveguide without zinc oxide (replaced by silicon dioxide) in the same structure at 20-50° C. is 3.6×10⁻⁵. In order to ensure the effective thermal-optical coefficient of the optical waveguide chip in this embodiment is 10⁻⁸-10⁻⁷, taking H²:W=0.024-0.034.

### Embodiment 2: The Linear Optical Waveguide

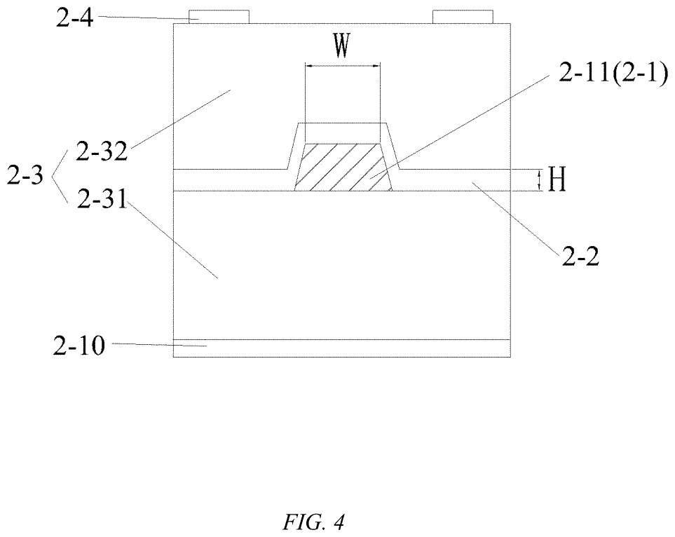

Referring to FIG. 4, in this embodiment, the lithium niobate optical waveguide is a linear optical waveguide, and the optimal thermo-optical coefficient of the optical waveguide chip with this structure at 20-50° C. is 1×10⁻⁸. As a comparison, the thermo-optical coefficient of the optical waveguide without titanium dioxide (replaced by silicon dioxide) in the same structure at 20-50° C. is 3.5×10⁻⁵.

In this embodiment, the lithium niobate optical waveguide comprises a monocrystalline silicon substrate (2-10), a lithium niobate film (2-1), a titanium dioxide layer (2-2) disposed on the lithium niobate film (2-1), a silicon dioxide cladding (2-3) coating the lithium niobate film (2-1) and the titanium dioxide layer (2-2), and metal electrodes (2-4) disposed on the silicon dioxide cladding (2-3). The thickness of the lithium niobate file (2-1) is 400 nm, which comprises a lithium niobate central ridge (2-11). The silicon dioxide cladding layer (2-3) comprises a lower cladding layer (2-31) disposed below the lithium niobate film (2-1) and an upper cladding layer (2-32) disposed above the titanium dioxide layer (2-2). The thickness of the lower cladding layer (2-31) is 4.7 μm, and the thickness of the upper cladding layer (2-32) is 1.5 μm. The lower cladding layer (2-31) is disposed on the monocrystalline silicon substrate (2-10), the lithium niobate central ridge (2-11) is convexly disposed on the lower cladding layer (2-31), the titanium dioxide layer (2-2) is disposed on the lithium niobate central ridge (2-11) and the upper cladding layer (2-32), and the metal electrodes (2-4) are disposed on opposite sides of the upper surfaces of the upper cladding layer (2-32).

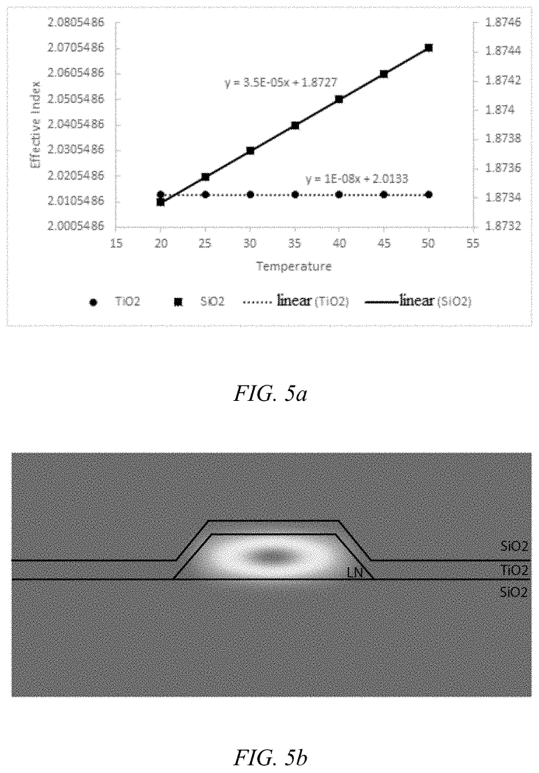

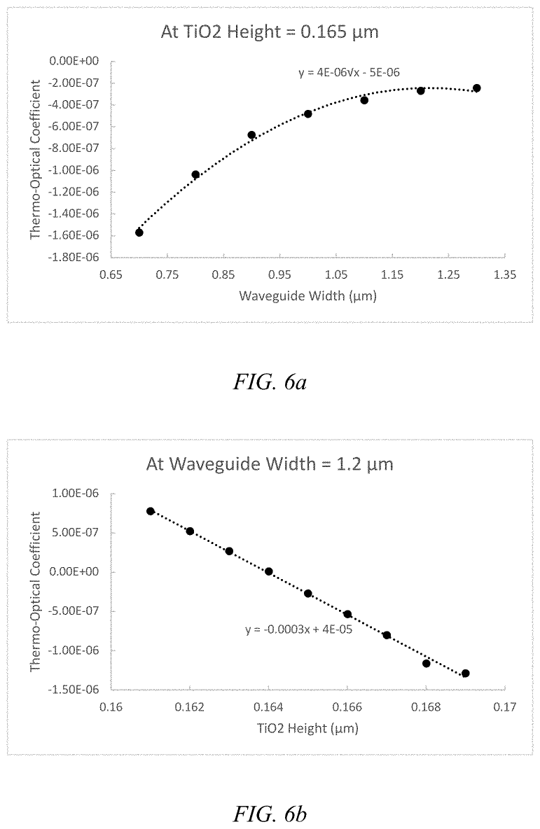

In this embodiment, the width of the lithium niobate central ridge (2-11) is W, the thickness of the titanium dioxide layer (2-2) is H, and satisfies H²:W=0.02-0.032, so as to ensure the effective thermal-optical coefficient of the optical waveguide in this embodiment is 10⁻⁸-10⁻⁷. FIG. 5a and FIG. 5b (FIG. 2 of annex 1) show the variation of effective refractive index with temperature and the distribution of optical fields of this optical waveguide structure, respectively. FIG. 6a and FIG. 6b show the variation of effective refractive index with the width of this optical waveguide structure and the thickness of the titanium dioxide layer, respectively.

If zinc oxide is used as the negative thermal-optical coefficient material, the optimal thermal-optical coefficient of the ridge optical waveguide with zinc oxide layer at 20-50° C. is 3.8×10⁻⁹. As a comparison, the thermo-optical coefficient of the optical waveguide without zinc oxide (replaced by silicon dioxide) in the same structure at 20-50° C. is 3.5×10⁻⁵. In order to ensure the effective thermal-optical coefficient of the optical waveguide chip in this embodiment is 10⁻⁸-10⁻⁷, taking H²:W=0.008-0.012.

### Embodiment 3: The Proton Exchange Optical Waveguide

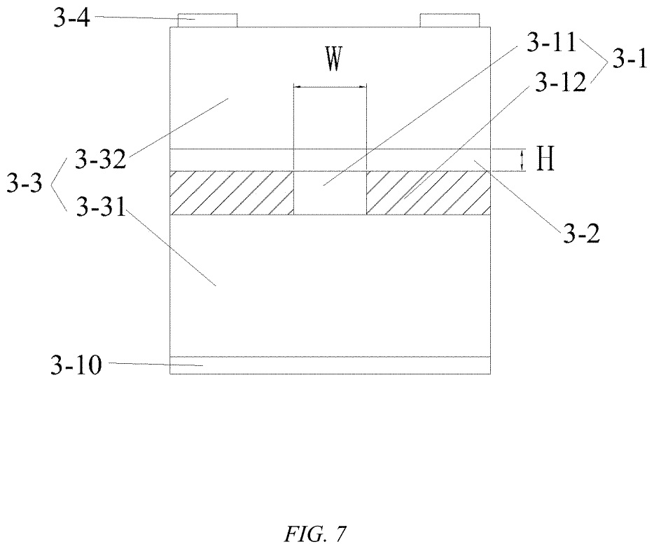

Referring to FIG. 7, in this embodiment, the lithium niobate optical waveguide is a proton exchange optical waveguide, and the optimal thermo-optical coefficient of the optical waveguide chip with this structure at 20-50° C. is 1.9×10⁻⁸. As a comparison, the thermo-optical coefficient of the optical waveguide without titanium dioxide (replaced by silicon dioxide) in the same structure at 20-50° C. is 3.4×10⁻⁵.

In this embodiment, the lithium niobate optical waveguide comprises a monocrystalline silicon substrate (3-10), a lithium niobate film (3-1), a titanium dioxide layer (3-2) disposed on the lithium niobate film (3-1), a silicon dioxide cladding (3-3) coating the lithium niobate film (3-1) and the titanium dioxide layer (3-2), and metal electrodes (3-4) disposed on the silicon dioxide cladding (3-3). The thickness of the lithium niobate file (3-1) is 500 nm, which comprises a proton-exchanged lithium niobate (PE:LN, 3-11) and lithium niobate side wings (3-12) stretching from the proton-exchanged lithium niobate (3-11) to both sides. The silicon dioxide cladding layer (3-3) comprises a lower cladding layer (3-31) disposed below the lithium niobate film (3-1) and an upper cladding layer (3-32) disposed above the titanium dioxide layer (3-2). The thickness of the lower cladding layer (3-31) is 2 μm, and the thickness of the upper cladding layer (3-32) is 1.5 μm. The lower cladding layer (3-31) is disposed on the monocrystalline silicon substrate (3-10), the proton-exchanged lithium niobate (3-11) is convexly disposed on the lower cladding layer (3-31), the lithium niobate side wings (3-12) stretched parallelly on the lower cladding layer (3-31), the titanium dioxide layer (3-2) is disposed on the proton-exchanged lithium niobate (3-11) and the lithium niobate side wings (3-12), and the metal electrodes (3-4) are disposed on opposite sides of the upper surfaces of the upper cladding layer (3-32).

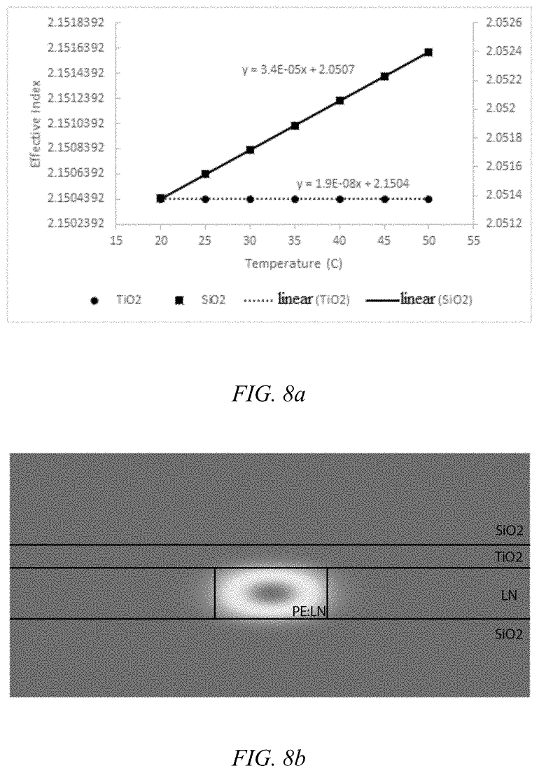

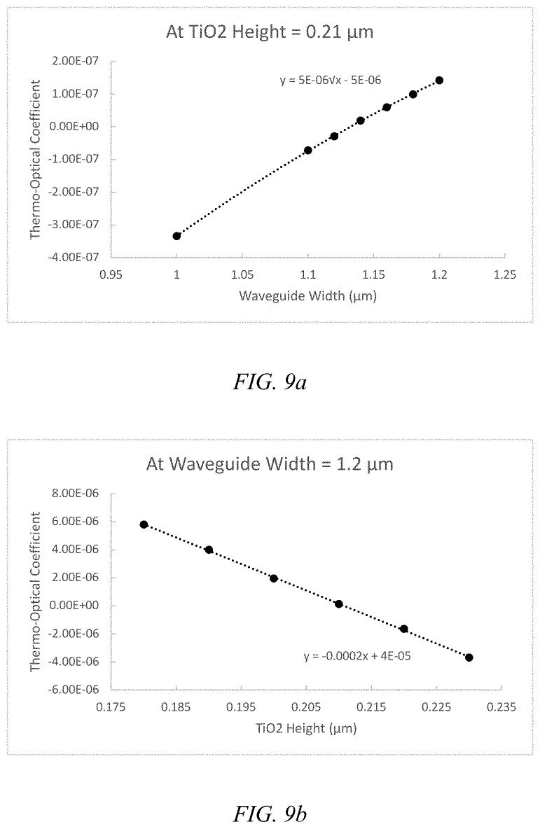

In this embodiment, the width of the proton-exchanged lithium niobate (3-11) is W, the thickness of the titanium dioxide layer (3-2) is H, and satisfies H²:W=0.037-0.042, so as to ensure the effective thermal-optical coefficient of the optical waveguide in this embodiment is 10⁻⁸-10⁻⁷. FIG. 8a and FIG. 8b (FIG. 3 of annex 1) show the variation of effective refractive index with temperature and the distribution of optical fields of this optical waveguide structure, respectively. FIG. 9a and FIG. 9b show the variation of effective refractive index with the width of this optical waveguide structure and the thickness of the titanium dioxide layer, respectively.

If zinc oxide is used as the negative thermal-optical coefficient material, the optimal thermal-optical coefficient of the ridge optical waveguide with zinc oxide layer at 20-50° C. is 3.4×10⁻⁸. As a comparison, the thermo-optical coefficient of the optical waveguide without zinc oxide (replaced by silicon dioxide) in the same structure at 20-50° C. is 3.4×10⁻⁵. In order to ensure the effective thermal-optical coefficient of the optical waveguide chip in this embodiment is 10⁻⁸-10⁻⁷, taking H²:W=0.045-0.07.

### Embodiment 4: The Channel Optical Waveguide

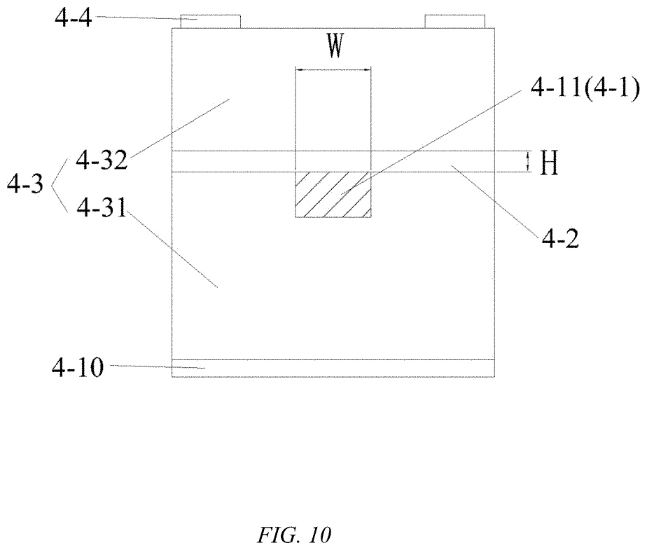

Referring to FIG. 10, in this embodiment, the lithium niobate optical waveguide is a channel optical waveguide, and the optimal thermo-optical coefficient of the optical waveguide chip with this structure at 20-50° C. is 1.2×10⁻⁸. As a comparison, the thermo-optical coefficient of the optical waveguide without titanium dioxide (replaced by silicon dioxide) in the same structure at 20-50° C. is 3.5×10⁻⁵.

In this embodiment, the lithium niobate optical waveguide comprises a monocrystalline silicon substrate (4-10), a lithium niobate film (4-1), a titanium dioxide layer (4-2) disposed on the lithium niobate film (4-1), a silicon dioxide cladding (4-3) coating the lithium niobate film (4-1) and the titanium dioxide layer (4-2), and metal electrodes (4-4) disposed on the silicon dioxide cladding (4-3). The thickness of the lithium niobate file (4-1) is 400 nm, which comprises a lithium niobate central ridge (4-11). The silicon dioxide cladding layer (4-3) comprises a lower cladding layer (4-31) disposed below the lithium niobate film (4-1) and an upper cladding layer (4-32) disposed above the titanium dioxide layer (4-2). The thickness of the lower cladding layer (4-31) is 2 μm, and the thickness of the upper cladding layer (4-32) is 1.5 μm. The lower cladding layer (4-31) is disposed on the monocrystalline silicon substrate (4-10), the lithium niobate central ridge (4-11) is concavely disposed in the lower cladding layer (4-31), the titanium dioxide layer (4-2) is disposed on the lithium niobate central ridge (4-11) and the lower cladding layer (4-31), and the metal electrodes (4-4) are disposed on opposite sides of the upper surfaces of the upper cladding layer (4-32).

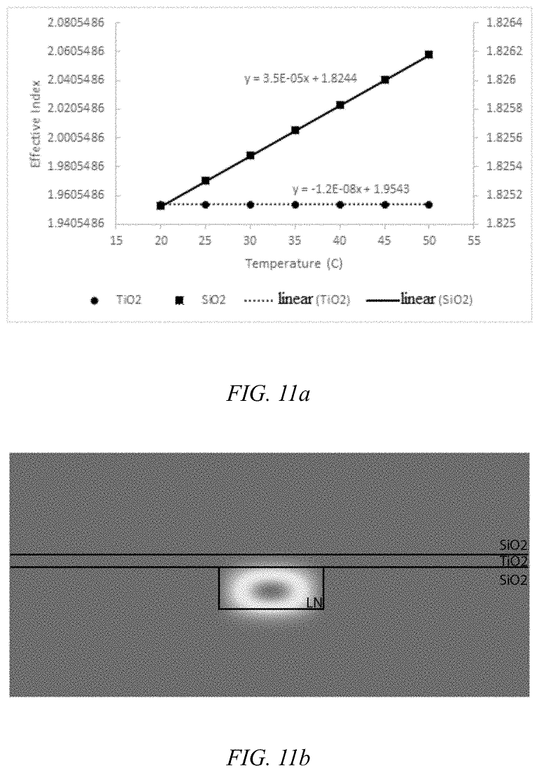

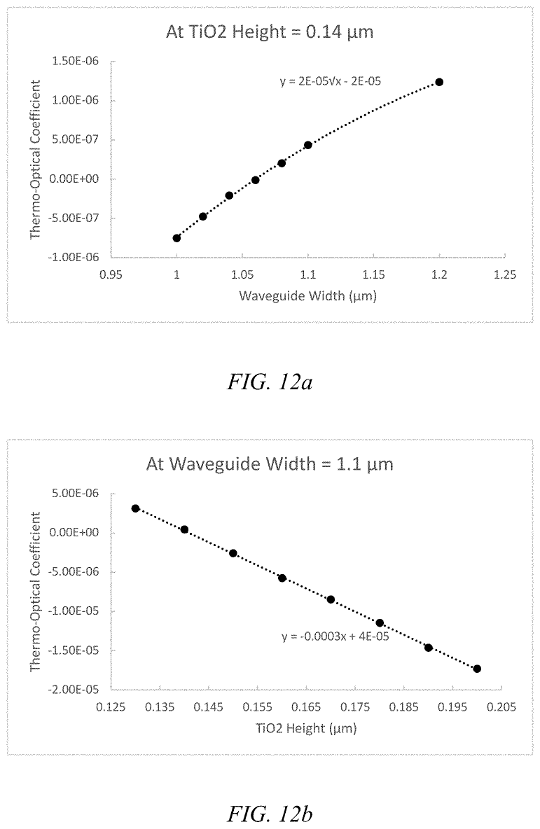

In this embodiment, the width of the lithium niobate central ridge (4-11) is W, the thickness of the titanium dioxide layer (4-2) is H, and satisfies H²:W=0.017-0.02, so as to ensure the effective thermal-optical coefficient of the optical waveguide in this embodiment is 10⁻⁸-10⁻⁷. FIG. 11a and FIG. 11b (FIG. 1 of annex 1) show the variation of effective refractive index with temperature and the distribution of optical fields of this optical waveguide structure, respectively. FIG. 12a and FIG. 12b show the variation of effective refractive index with the width of this optical waveguide structure and the thickness of the titanium dioxide layer, respectively.

If zinc oxide is used as the negative thermal-optical coefficient material, the optimal thermal-optical coefficient of the ridge optical waveguide with zinc oxide layer at 20-50° C. is 1.7×10⁻⁸. As a comparison, the thermo-optical coefficient of the optical waveguide without zinc oxide (replaced by silicon dioxide) in the same structure at 20-50° C. is 3.5×10⁻⁵. In order to ensure the effective thermal-optical coefficient of the optical waveguide chip in this embodiment is 10⁻⁸-10⁻⁷, taking H²:W=0.008-0.012.

To sum up, since the refractive index of lithium niobate and silicon oxide increases along with temperature rise, on the basis of the characteristics that the refractive index of the negative thermo-optical coefficient materials decreases along with temperature rise, the present invention can eliminate the sensitivity of the effective refractive index of the lithium niobate optical waveguides to temperature by disposing the negative thermo-optical coefficient material layer with appropriate thickness on the lithium niobate film. The present invention realizes the design of non-thermal photoelectric devices, can effectively reduce the thermo-optical coefficient of the lithium niobate optical waveguide chip, so as to make the performance of the lithium niobate optical waveguide chip insensitive to temperature change.

The technical features of the above embodiments can be combined arbitrarily, in order to make the description concise, not all possible combinations of the technical features in the above embodiments are described. However, as long as there is no contradiction between the combination of these technical features, they shall be considered to be within the scope of this specification.

The present invention only described several above embodiments, which are described more specific and detailed, but it cannot be understood as a limitation on the scope of the present invention. It should be pointed out that for ordinary technical personnel in the art, without departing from the concept of the present invention, a number of deformation and improvements can be made, which belong to the scope of the present invention. Therefore, the scope of the present invention shall be subject to the recorded claims.

1. A lithium niobate optical waveguide chip, characterized in that including: a monocrystalline silicon substrate, a lithium niobate film, a negative thermo-optical coefficient material disposed on the lithium niobate film, a silicon dioxide cladding disposed on the monocrystalline silicon substrate and coating the lithium niobate film and the negative thermo-optical coefficient material, and a metal electrode disposed on the silicon dioxide cladding; the lithium niobate film comprises a lithium niobate central ridge, or comprises a proton exchange layer and lithium niobate side wings.

2. The lithium niobate optical waveguide chip according to claim 1, characterized in that the thermal-optical coefficient of the lithium niobate optical waveguide chip is in the range of 10-8 to 10-7.

3. The lithium niobate optical waveguide chip according to claim 1, characterized in that the width of the lithium niobate central ridge is in the range of 0.7 μm to 1.5 μm, and the width of the proton exchange layer is in the range of 0.7 μm to 1.5 μm.

4. The lithium niobate optical waveguide chip according to claim 1, characterized in that the silicon dioxide cladding layer comprises a lower cladding layer disposed between the lithium niobate film and monocrystalline silicon substrate, and an upper cladding layer disposed above the negative thermo-optical coefficient material; and the metal electrode is disposed on opposite sides of the upper cladding.

5. The lithium niobate optical waveguide chip according to claim 4, characterized in that the lithium niobate optical waveguide chip is ridge optical waveguide, the lithium niobate film comprises the lithium niobate central ridge and lithium niobate side wings stretching from the lithium niobate center ridge to both sides, the lithium niobate central ridge is convexly disposed on the lower cladding layer, the lithium niobate side wings stretched parallelly on the lower cladding layer; and the negative thermo-optical coefficient material is disposed on the lithium niobate central ridge and lithium niobate side wings; and the width of the lithium niobate central ridge is W, the thickness of the negative thermo-optical coefficient material (taking titanium dioxide as an example) is H, and satisfies H2:W=0.034-0.041.

6. The lithium niobate optical waveguide chip according to claim 4, characterized in that the lithium niobate optical waveguide chip is linear optical waveguide, the lithium niobate film comprises the lithium niobate central ridge, the lithium niobate central ridge is convexly disposed on the lower cladding layer, the negative thermo-optical coefficient material is disposed on the lithium niobate central ridge; and the width of the lithium niobate central ridge is W, the thickness of the negative thermo-optical coefficient material (taking titanium dioxide as an example) is H, and satisfies H2:W=0.02-0.032.

7. The lithium niobate optical waveguide chip according to claim 4, characterized in that the lithium niobate optical waveguide chip is proton exchange optical waveguide, the lithium niobate film comprises the proton exchange layer and lithium niobate side wings stretching from the proton exchange layer to both sides, the proton exchange layer and lithium niobate side wings are arranged parallel to the lower cladding layer, the negative thermo-optical coefficient material is disposed on the proton exchange layer and lithium niobate side wings; the width of the proton exchange layer is W, the thickness of the negative thermo-optical coefficient material (taking titanium dioxide as an example) is H, and satisfies H2:W=0.037-0.042.

8. The lithium niobate optical waveguide chip according to claim 4, characterized in that the lithium niobate optical waveguide chip is channel optical waveguide, the lithium niobate film comprises the lithium niobate central ridge, which is concavely disposed in the lower cladding layer, the negative thermo-optical coefficient material is disposed on the lithium niobate central ridge and parallel to the lower cladding layer; the width of the lithium niobate central ridge is W, the thickness of the negative thermo-optical coefficient material (taking titanium dioxide as an example) is H, and satisfies H2:W=0.017-0.02.

9. The lithium niobate optical waveguide chip according to claim 1, characterized in that the proton exchange layer is proton-exchanged lithium niobate.

10. The lithium niobate optical waveguide chip according to claim 1, characterized in that the negative thermo-optical coefficient material is selected from one or more of titanium dioxide, zinc oxide, magnesium doped zinc oxide, polymethyl methacrylate, polystyrene, and methylammonium lead halide.
